(19) United States
(12) Patent Application Publication
(10) Pub. No.: US 2007/0036270 A1
(43) Pub. Date: Feb. 15, 2007

(54) Radiographic apparatus and radiation detection signal processing method

(75) Inventors: Shoichi Okamura, Nara-ken (JP); Koichi Tanabe, Kyoto (JP)

Correspondence Address: RADER FISHMAN & GRAUER PLLC, LION BUILDING, 1233 20TH STREET N.W., SUITE 501, WASHINGTON, DC, 20036, US

(73) Assignee: Shimadzu Corporation

(21) Appl. No.: 11/411,017

(22) Filed: Apr. 26, 2006

(30) Foreign Application Priority Data
Jan. 6, 2005 (JP) JP2005-161573

(51) Int. Cl. H05G 1/64

(52) U.S. Cl. 378/98.12

(57) ABSTRACT

When performing a lag correction of a lag-behind part by eliminating the lag-behind part from an X-ray detection signal obtained, a plurality of X-ray detection signals in time of non-irradiation before X-ray irradiation in an imaging event, and a lag image based on the X-ray detection signals acquired. The lag correction performed by subtracting the lag image acquired from the X-ray detection signal. Thus, the lag-behind part is eliminated from the X-ray detection signal in a simple way.

### BACKGROUND OF THE INVENTION

(1) Field of the Invention

This invention relates to a radiographic apparatus and a radiation detection signal processing method for obtaining radiographic images based on radiation detection signals resulting from radiation emitted to and transmitted through an object under examination. More particularly, the invention relates to a technique for eliminating lag-behind parts from the radiation detection signals.

(2) Description of the Related Art

An example of radiographic apparatus is an imaging apparatus that obtains X-ray images by detecting X rays. This apparatus used an image intensifier as an X-ray detecting device in the past. In recent years, a flat panel X-ray detector (hereinafter called simply “FPD”) has come to be used instead.

The FPD has a sensitive film laminated on a substrate, detects radiation incident on the sensitive film, converts the detected radiation into electric charges, and stores the electric charges in capacitors arranged in a two-dimensional array. The electric charges are read by turning on switching elements, and are transmitted as radiation detection signals to an image processor. The image processor obtains an image having pixels based on the radiation detection signals.

The FPD is lightweight and free from complicated detecting distortions compared with the image intensifier used heretofore. Thus, the, FPD has advantages in terms of apparatus construction and image processing.

However, when the FPD is used, the X-ray detection signals include lag-behind parts. A lag-behind part results in an afterimage from X-ray irradiation in a preceding imaging event appearing as an artifact on a next X-ray image. Particularly, in a fluoroscopy that performs X-ray irradiation continually at short time intervals (e.g. 1/30 second), time lags of the lag-behind parts have influences serious enough to hinder diagnosis.

Japanese Unexamined Patent Publication No. H9-9153 discloses a technique for reducing long time constant components of lag-behind parts by using backlight. Japanese Unexamined Patent Publication No. 2004-242741 discloses a technique for reducing artifacts due to lag-behind parts by regarding the lag-behind parts as a total of exponential functions having a plurality of time constants, and performing a lag correction by recursive computation using these exponential functions.

However, where backlight is used as disclosed in the Japanese Unexamined Patent Publication No. H9-9153 noted above, the construction becomes complicated by a construction required for backlight. Particularly where backlight is used in an FPD having a lightweight construction, the construction must become heavy and complicated again. In the case of Japanese Unexamined Patent Publication No. 2004-242741, the lag correction must be carried out by performing recursive computations the number of times X-ray detection signals are sampled. This renders the lag correction complicated and cumbersome.

### SUMMARY OF THE INVENTION

This invention has been made having regard to the state of the art noted above, and its object is to provide a radiographic apparatus and a radiation detection signal processing method for eliminating lag-behind parts from radiation detection signals in a simple way.

The above object is fulfilled, according to this invention, by a radiographic apparatus for obtaining radiographic images based on radiation detection signals, comprising a radiation emitting device for emitting radiation toward an object under examination; a radiation detecting device for detecting radiation transmitted through the object; a lag correcting device for performing a lag correction of a lag-behind part by eliminating the lag-behind part from a radiation detection signal; a non-irradiation signal acquiring device for acquiring a plurality of radiation detection signals in time of non-irradiation before irradiation of the radiation in an imaging event; and a lag image acquiring device for acquiring a lag image based on the radiation detection signals acquired by the non-irradiation signal acquiring device; wherein the lag correcting device is arranged to perform the lag correction by subtracting the lag image acquired by the lag image acquiring device from a radiographic image serving an intended purpose.

With the radiographic apparatus according to this invention, the lag correcting device performs a lag correction of a lag-behind part by eliminating the lag-behind part from a radiation detection signal, and the non-irradiation signal acquiring device acquires a plurality of radiation detection signals in time of non-irradiation before irradiation of the radiation in an imaging event. The lag image acquiring device acquires a lag image based on the radiation detection signals acquired by the non-irradiation signal acquiring device. The lag correcting device performs the lag correction by subtracting the lag image acquired by the lag image acquiring device from a radiographic image serving the intended purpose. Thus, there is no need to carry out a lag correction by performing recursive computations the number of times radiation detection signals are sampled, as described in Japanese Unexamined Patent Publication No. 2004-242741 noted hereinbefore. A lag-behind part may be eliminated from a radiation detection signal in a simple way. Further, there is no need to use backlight as used in Japanese Unexamined Patent Publication No. H9-9153 noted hereinbefore. This avoids complication of the apparatus construction.

In another aspect of the invention, a radiation detection signal processing method is provided for obtaining radiographic images based on radiation detection signals resulting from radiation emitted to and transmitted through an object under examination, the radiation detection signal processing method comprising the steps of acquiring a plurality of radiation detection signals in time of non-irradiation before irradiation of the radiation in an imaging event, for performing a lag correction of a lag-behind part by eliminating the lag-behind part from a radiation detection signal obtained; acquiring a lag image based on the radiation detection signals acquired; and performing the lag correction by subtracting the lag image acquired from a radiographic image serving an intended purpose.

With the radiation detection signal processing method according to this invention, for performing a lag correction of a lag-behind part by eliminating the lag-behind part from a radiation detection signal obtained, a plurality of radiation detection signals are acquired in time of non-irradiation before irradiation of the radiation in an imaging event, and a lag image is acquired based on the radiation detection signals acquired. The lag correction is performed by subtracting the lag image from a radiographic image serving the intended purpose. Thus, there is no need to carry out a lag correction by performing recursive computations the number of times radiation detection signals are sampled, as described in Japanese Unexamined Patent Publication No. 2004-242741 noted hereinbefore. A lag-behind part may be eliminated from a radiation detection signal in a simple way.

In this invention described above, it is preferred that a plurality of radiation detection signals are acquired in time of non-irradiation after lapse of a predetermined time from irradiation of the radiation in a preceding imaging event, which results in an acquisition of a plurality of radiation detection signals in time of non-irradiation before irradiation of the radiation in a current imaging event.

When the irradiation in the preceding imaging event is completed and a transition is made to a state of non-irradiation, short time constant components or medium time constant components of a lag-behind part attenuate in a short time. After their attenuation, long time constant components become dominant, and remain with substantially the same intensity. Consequently, when a radiation detection signal is acquired immediately after completion of the irradiation in the preceding imaging event, short and medium time constant components are included in the signal acquired. The lag-behind parts having the short and medium time constant components cannot be eliminated from the signal accurately.

Thus, a plurality of radiation detection signals are acquired in time of non-irradiation after lapse of the predetermined time from the irradiation in the preceding imaging event. Consequently, a plurality of radiation detection signals are acquired in time of non-irradiation before irradiation in the current imaging event. A signal may be acquired in a state of including only the long time constant components which remain after lapse of the predetermined time. The signal is free from the short and medium time constant components, and a lag-behind part having the long time constant components may be eliminated accurately.

In one example according to the invention, at least a radiation detection signal immediately preceding a start of irradiation of the radiation in the imaging event is acquired by repeating a process of acquiring a radiation detection signal in time of the non-irradiation; and the radiation detection signal immediately preceding the start of irradiation is acquired as the lag image.

In the above example, the radiation detection signal immediately preceding the start of irradiation of the radiation in the imaging event may be acquired by repeating a process of newly acquiring a radiation detection signal in time of the non-irradiation, and retaining a radiation detection signal acquired at a previous point of time; and the radiation detection signal immediately preceding the start of irradiation may be acquired as the lag image.

Alternatively, the radiation detection signal immediately preceding the start of irradiation of the radiation in the imaging event may be acquired by repeating a process of newly acquiring a radiation detection signal in time of the non-irradiation, and then discarding a radiation detection signal acquired at a previous point of time; and the radiation detection signal immediately preceding the start of irradiation may be acquired as the lag image.

Where the radiation detection signal acquired at a previous point of time is discarded, the radiation detection signal immediately preceding the start of irradiation of the radiation in the imaging event may be acquired in the following specific example. Each of the radiation detection signals is acquired through sampling, and the radiation detection signal immediately preceding the start of irradiation in the imaging event is acquired by repeating processes of (1) acquiring a radiation detection signal in time of non-irradiation, (2) checking whether the imaging event has been reached; (3) incrementing the value of K by 1, and (4) discarding a radiation detection signal acquired at a previous point of time, where sampling points of time K are 0, 1, 2 and so on, and a first one of the radiation detection signals is acquired at a sampling point of time K=0, at each of sampling time intervals until the imaging event is found in process (2) to have been reached.

In another example according to the invention, radiation detection signals are acquired successively in time of non-irradiation, without discarding the radiation detection signals until a predetermined number of radiation detection signals are acquired; a process is repeated, after the predetermined number is reached, for discarding only an oldest one of the radiation detection signals when a new radiation detection signal is acquired in time of non-irradiation, thereby acquiring the predetermined number of radiation detection signals including a radiation detection signal immediately preceding a start of irradiation of the radiation in the imaging event; and the lag image is acquired based on the predetermined number of radiation detection signals including the radiation detection signal acquired immediately preceding the start of irradiation.

Where the radiation detection signals are not discarded until the predetermined number of radiation detection signals are acquired in time of non-irradiation, the predetermined number of radiation detection signals may be acquired in the following specific example. Each of the radiation detection signals is acquired through sampling, and the predetermined number of radiation detection signals are acquired by repeating processes of (1) acquiring a radiation detection signal in time of non-irradiation, (2) checking whether the predetermined number has been reached; and (3) incrementing the value of K by 1, where sampling points of time K are 0, 1, 2 and so on, and a first one of the radiation detection signals is acquired at a sampling point of time K=0, at each of sampling time intervals until the predetermined number is found in process (2) to have been reached; and the lag image is acquired based on the predetermined number of radiation detection signals including the radiation detection signal immediately preceding the start of irradiation by repeating, after the prescribed number is reached, processes of (4) acquiring of the radiation detection signals in time of non-irradiation, (5) checking whether the imaging event has been reached; (6) incrementing the value of K by 1, and (7) discarding only the oldest one of the radiation detection signals, at each of the sampling time intervals until the imaging event is found in process (5) to have been reached.

Where the radiation detection signals are not discarded until the predetermined number of radiation detection signals are acquired in time of non-irradiation, an average of the predetermined number of radiation detection signals including the radiation detection signal acquired immediately preceding the start of irradiation may be acquired as the lag image.

In a further example according to the invention, the plurality of radiation detection signals are acquired in time of the non-irradiation by successively acquiring the radiation detection signals; and the lag image is acquired based on a plurality of radiation detection signals successively acquired so far in time of non-irradiation including a given point of time, by repeating a recursive computation based on a radiation detection signal acquired at the given point of time, and a lag image derived from a plurality of radiation detection signals successively acquired so far and at points of time before the given point of time.

In this example, whenever a radiation detection signal is acquired in time of non-irradiation, the recursive computation is repeated based on the latest radiation detection signal acquired, and the lag image resulting from a plurality of radiation detection signals successively acquired in the past. The lag image ultimately obtained is a goal image used as the basis for the lag correction. Only the newest lag image obtained by recursive computation and the lag image (i.e. the lag image used as the basis of the recursive computation) before the newest lag image may be retained, with the other lag images (i.e. the lag images earlier than the above two lag images) discarded. Then, only the two images may be retained, which provides an advantage of simplifying the construction.

One example of recursive computation is a recursive weighted average. With the lag image acquired from the weighted average, the lag correction may be carried out with increased reliability.

For the recursive weighted average, the lag image may be acquired in the following specific example. The lag image L_{N} is derived from the recursive weighted average expressed by;

L_{N}=(1−P)×L_{N-1}+P×I_{N} (on condition that lag image L₀ of initial value is radiation detection signal I₀ acquired first in time of non-irradiation), where I_{N} is a radiation detection signal acquired at the given point of time, L_{N-1} is the lag image derived from the plurality of radiation detection signals successively acquired so far and at points of time before the given point of time, and P is a load ratio.

The recursive computation for acquiring the lag image in the above example is not limited to the recursive weighted average, but may be an unweighted recursive computation. Thus, function f (I_{N}, L_{N-1}) expressed by X-ray detection signal I_{N} and lag image L_{N-1} may be expressed by the lag image L_{N} to serve the purpose.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram of a fluoroscopic apparatus according to the invention;

FIG. 2 is an equivalent circuit, seen in side view, of a flat panel X-ray detector used in the fluoroscopic apparatus;

FIG. 3 is an equivalent circuit, seen in plan view, of the flat panel X-ray detector;

FIG. 4 is a flow chart showing a series of signal processing by a lag correcting unit, a non-irradiation signal acquiring unit and a lag image acquiring unit in a first embodiment;

FIG. 5 is a time chart showing X-ray emissions and acquisition of X-ray detection signals;

FIG. 6 is a schematic view showing a flow of data to and from an image processor and a memory in the first and second embodiments;

FIG. 7 is a flow chart showing a series of signal processing by a lag correcting unit, a non-irradiation signal acquiring unit and a lag image acquiring unit in the second embodiment;

FIG. 8 is a schematic view showing flows of data to and from an image processor and a memory in a third embodiment;

FIG. 9 is a flow chart showing a series of signal processing by a lag correcting unit, a non-irradiation signal acquiring unit and a lag image acquiring unit in the third embodiment; and

FIG. 10 is a schematic view showing variations of random noise occurring with the frequency of recursive computation when load ratios are changed in the third embodiment.

### DESCRIPTION OF THE PREFERRED EMBODIMENTS

Preferred embodiments of this invention will be described in detail hereinafter with reference to the drawings.

### First Embodiment

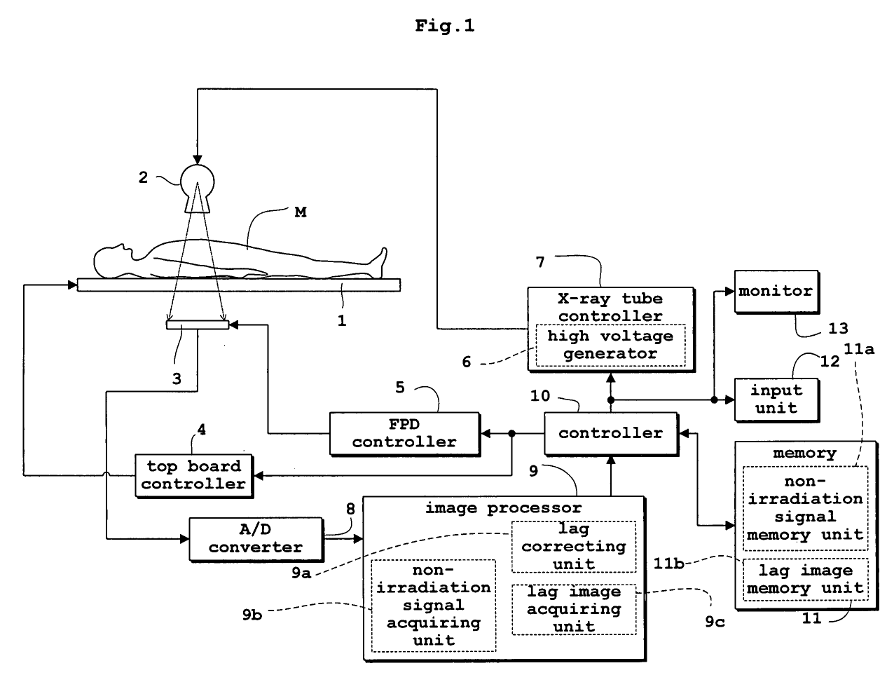

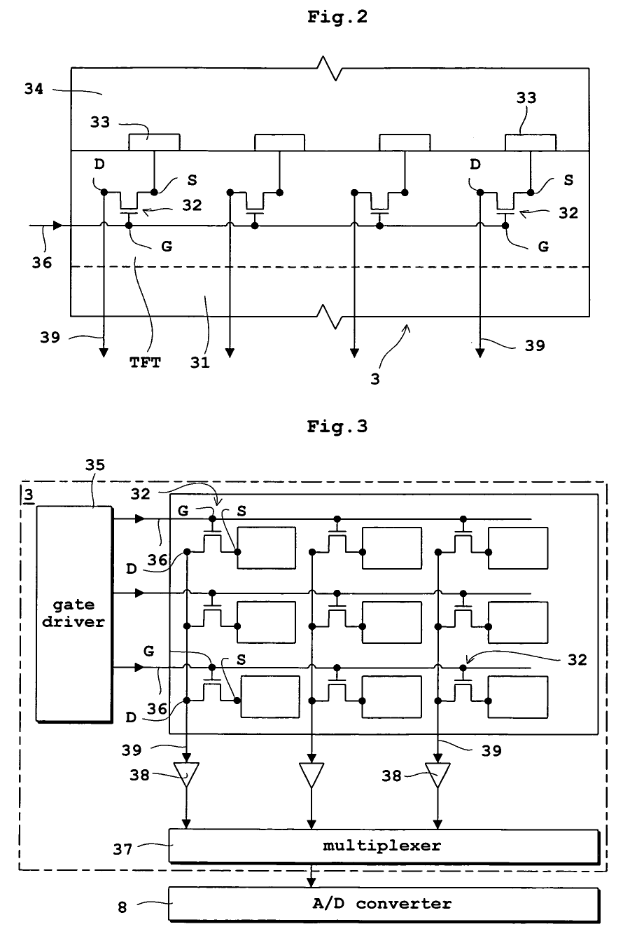

FIG. 1 is a block diagram of a fluoroscopic apparatus in the first embodiment. FIG. 2 is an equivalent circuit, seen in side view, of a flat panel X-ray detector used in the fluoroscopic apparatus. FIG. 3 is an equivalent circuit, seen in plan view, of the flat panel X-ray detector. The first embodiment, and also the second and third embodiments to follow, will be described, taking the flat panel X-ray detector (hereinafter called “FPD” as appropriate) as an example of radiation detection device, and the fluoroscopic apparatus as an example of radiographic apparatus.

As shown in FIG. 1, the fluoroscopic apparatus in the first embodiment includes a top board 1 for supporting a patient M, an X-ray tube 2 for emitting X rays toward the patient M, and an FPD 3 for detecting X rays transmitted through the patient M. The X-ray tube 2 corresponds to the radiation emitting device in this invention. The FPD 3 corresponds to the radiation detecting device in this invention.

The fluoroscopic apparatus further includes a top board controller 4 for controlling vertical and horizontal movements of the top board 1, an FPD controller 5 for controlling scanning action of the FPD 3, an X-ray tube controller 7 having a high voltage generator 6 for generating a tube voltage and tube current for the X-ray tube 2, an analog-to-digital converter 8 for fetching charge signals from the FPD 3 and digitizing the charge signals into X-ray detection signals, an image processor 9 for performs various processes based on the X-ray detection signals outputted from the analog-to-digital converter 8, a controller 10 for performing an overall control of these components, a memory 11 for storing processed images, an input unit 12 for the operator to input various settings, and a monitor 13 for displaying the processed images and other information.

The top board controller 4 controls movements of the top board 1, such as moving the top board 1 horizontally to place the patient M in an imaging position, vertically moving and/or rotating the top board 1 to set the patient M to a desired position, horizontally moving the top board 1 during an imaging operation, and horizontally moving the top board 1 to withdraw the patient M from the imaging position after the imaging operation. The FPD controller 5 controls scanning action by moving the FPD 3 horizontally or revolving the FPD 3 about the body axis of patient M. The high voltage generator 6 generates the tube voltage and tube current for the X-ray tube 2, to emit X rays. The X-ray tube controller 7 controls scanning action by moving the X-ray tube 2 horizontally or revolving the X-ray tube 2 about the body axis of patient M, and controls setting of a coverage of a collimator (not shown) disposed adjacent the X-ray tube 2. In time of scanning action, the X-ray tube 2 and FPD 3 are moved while maintaining a mutually opposed relationship, so that the FPD 3 may detect X rays emitted from the X-ray tube 2.

The controller 10 has a central processing unit (CPU) and other elements. The memory 11 has storage media, typically a ROM (Read-Only Memory) and RAM (Random Access Memory). The input unit 12 has a pointing device, typically a mouse, keyboard, joy stick, trackball and/or touch panel. The fluoroscopic apparatus creates images of the patient M, with the FPD 3 detecting X rays transmitted through the patient M, and the image processor 9 performing an image processing based on the X rays detected.

The image processor 9 includes a lag correcting unit 9a for performing a lag correction by eliminating any lag-behind parts from the X-ray detection signals, a non-irradiation signal acquiring unit 9b for acquiring a plurality of X-ray detection signals in time of non-irradiation before X-ray irradiation in an imaging event, a lag image acquiring unit 9c for acquiring a lag image based on these X-rays detection signals acquired by the non-irradiation signal acquiring unit 9b. The above lag correcting unit 9a performs the lag correction by subtracting the lag image acquired by the lag image acquiring unit 9c from an X-ray image serving an intended purpose. The lag correcting unit 9a corresponds to the lag correcting device in this invention. The non-irradiation signal acquiring unit 9b corresponds to the non-irradiation signal acquiring device in this invention. The lag image acquiring unit 9c corresponds to the lag image acquiring device in this invention.

The memory 11 includes a non-irradiation signal memory unit 11a for storing X-ray detection signals acquired by the non-irradiation signal acquiring unit 9b in time of non-irradiation, and a lag image memory unit 11b for storing the lag image acquired by the lag image acquiring unit 9c. In the first embodiment, and also in the second embodiment described hereinafter, the lag image acquiring unit 9c acquires a lag image based on the X-ray detection signals of non-irradiation times read from the non-irradiation signal memory unit 11a (see FIG. 6). In the third embodiment to follow, a lag image is obtained by a recursive weighted average (recursive process) as described hereinafter (see FIG. 8). In the first embodiment, and also in the second and third embodiments, the lag correcting unit 9a subtracts from the X-ray image the lag image read from the lag image memory unit 11b.

As shown in FIG. 2, the FPD 3 includes a glass substrate 31, and thin film transistors TFT formed on the glass substrate 31. As shown in FIGS. 2 and 3, the thin film transistors TFT comprise numerous (e.g. 1,024×1,024) switching elements 32 arranged in a two-dimensional matrix of rows and columns. The switching elements 32 are formed separate from one another for respective carrier collecting electrodes 33. Thus, the FPD 3 is also a two-dimensional array radiation detector.

As shown in FIG. 2, an X-ray sensitive semiconductor 34 is laminated on the carrier collecting electrodes 33. As shown in FIGS. 2 and 3, the carrier collecting electrodes 33 are connected to the sources S of the switching elements 32. A plurality of gate bus lines 36 extend from a gate driver 35, and are connected to the gates G of the switching elements 32. On the other hand, as shown in FIG. 3, a plurality of data bus lines 39 are connected through amplifiers 38 to a multiplexer 37 for collecting charge signals and outputting as one. As shown in FIGS. 2 and 3, each data bus line 39 is connected to the drains D of the switching elements 32.

With a bias voltage applied to a common electrode not shown, the gates of the switching elements 32 are turned on by applying thereto (or reducing to 0V) the voltage of the gate bus lines 36. The carrier collecting electrodes 33 output charge signals (carriers) converted from X rays incident on the detection surface through the X-ray sensitive semiconductor 34, to the data bus lines 39 through the sources S and drains D of the switching elements 32. The charge signals are provisionally stored in capacitors (not shown) until the switching elements are turned on. The amplifiers 38 amplify the charge signals read out to the data bus lines 39, and the multiplexer 37 collects the charge signals, and outputs them as one charge signal. The analog-to-digital converter 8 digitizes the outputted charge signal, and outputs it as an X-ray detection signal.

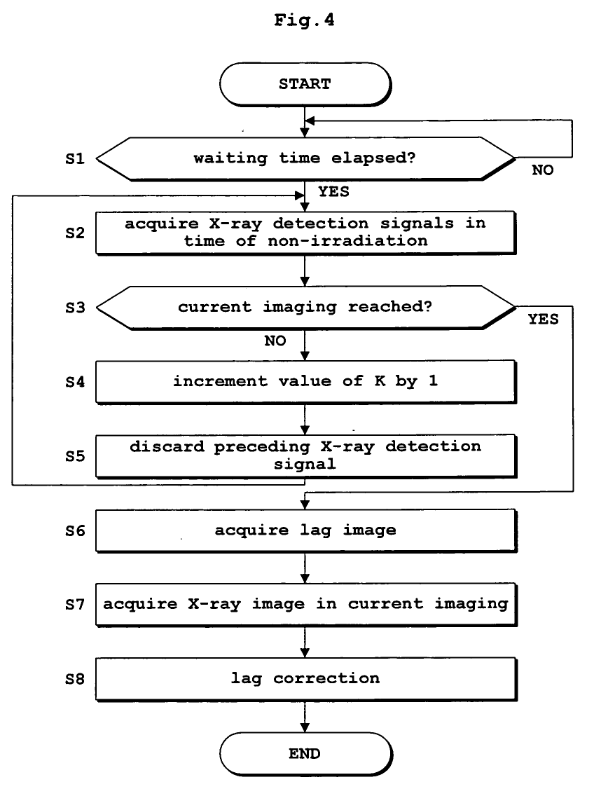

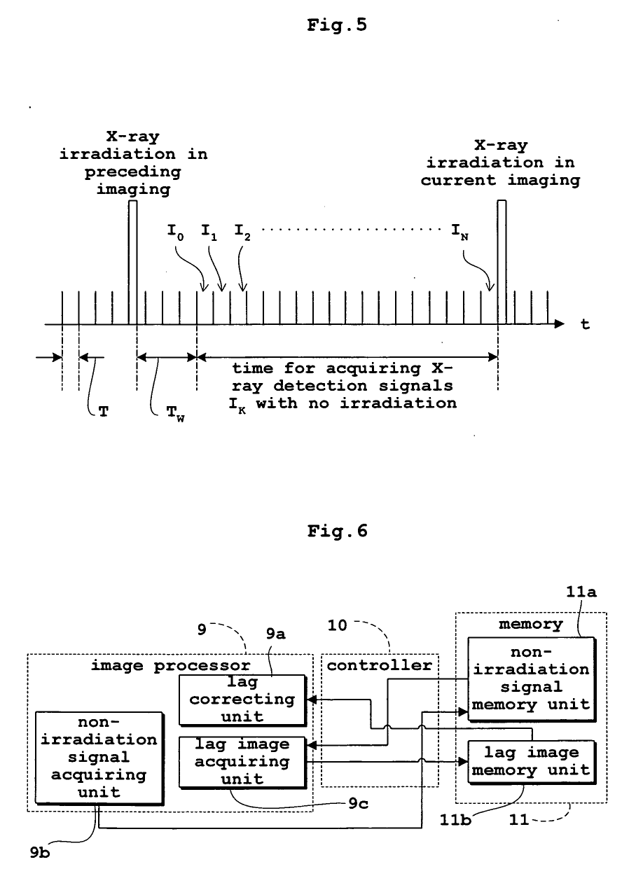

Next, a series of signal processing by the lag correcting unit 9a, non-irradiation signal acquiring unit 9b and lag image acquiring unit 9c in the first embodiment will be described with reference to the flow chart shown in FIG. 4 and the time chart shown in FIG. 5. This processing will be described by taking for example what takes place from an end of X-ray irradiation in a preceding imaging event to X-ray irradiation in a current imaging event.

(Step S1) Waiting Time elapsed?

A checking is made whether or not a predetermined waiting time T_{W} has elapsed from the end of X-ray irradiation in the preceding imaging event as shown in FIG. 5. Immediately after the end of irradiation, a lag-behind part includes numerous short time constant components or medium time constant components. These short or medium time constant components attenuate in a short time. After their attenuation, long time constant components become dominant, and remain with substantially the same intensity. Thus, the waiting time T_{W} is provided so that X-ray detection signals may be acquired in time of non-irradiation after lapse of the predetermined time from X-ray irradiation in the preceding imaging event. Upon lapse of the waiting time T_{W}, the operation proceeds to next step S2. Whether the waiting time T_{W} has passed or not may be determined by means of a timer (not shown). That is, the timer is reset to “0” to start counting simultaneously with the termination of X-ray irradiation in the preceding imaging event. It may be determined, when a count corresponding to the waiting time T_{W} is reached, that the waiting time T_{W} has passed. The waiting time T_{W} corresponds to the predetermined time in this invention.

The waiting time T_{W}, preferably, is about 15 seconds although this depends on the lag characteristics of individual FPD 3, and the waiting time T_{W} of about 30 seconds should be sufficient. The longer waiting time T_{W}, e.g. at least 30 seconds, is the better. However, an excessively long time means an extended interval between imaging events. It is realistic for practical purposes to set the waiting time T_{W} to about 3 seconds.

(Step S2) Acquire X-ray Detection Signals in Time of Non-irradiation

The non-irradiation signal acquiring unit 9b successively acquires X-ray detection signals at sampling time intervals (e.g. 1/30 second) in time of non-irradiation after lapse of the waiting time T_{W}. The number of sampling times before start of the X-ray irradiation in the current imaging operation is set to (N+1) (however, K=0, 1, 2, . . . , N−1 and N), with K=0 indicating the first signal acquired immediately after lapse of the waiting time T_{W}. With a (K+1)th X-ray detection signal regarded as I_{K}, the first X-ray detection signal acquired immediately after lapse of the waiting time T_{W} is I₀, and the X-ray detection signal acquired immediately before start of X-ray irradiation in the current imaging event is I_{N}. It is assumed here that steps S2-S5 are successively executed for each sampling time interval (cycle T corresponding to each frame in FIG. 5).

(Step S3) Current Imaging Reached?

A checking is made whether or not the time for acquiring X-ray detection signals in step S2, i.e. sampling time, has reached the start of X-ray irradiation in the current imaging event (whether or not K=N+1). When it has been reached, the operation jumps to step S6. Otherwise, next step S4 is executed.

(Step S4) Increment Value of K by 1

The value of subscript K is incremented by 1 for a next sampling.

(Step S5) Discard Preceding X-ray Detection Signal

X-ray detection signal I_{K} acquired by the non-irradiation signal acquiring unit 9b in step S2 is written and stored in the non-irradiation signal memory unit 11a. At this time, X-ray detection signal I_{K-1} acquired before X-ray detection signal I_{K} is discarded as no longer necessary. Thus, only the latest X-ray detection signal remains stored in the non-irradiation signal memory unit 11a. When the operation proceeds to step S5 after incrementing K=0 to K=1 in step S4, there exits no X-ray detection signal preceding signal I₀, and thus no signal to be discarded. Then, the operation returns to step S2 for a next sampling, and repeats steps S2-S5 for each of the sampling time intervals. While, in the first embodiment, preceding X-ray detection signals are discarded and only the latest X-ray detection signal is retained, it is of course not absolutely necessary to discard the earlier signals.

(Step S6) Acquire Lag Image

When the sampling time has reached the start of X-ray irradiation in the current imaging event in step S3, the (N+1)th X-ray detection signal I_{N} acquired in step S2 is employed as a lag image. That is, the lag image acquiring unit 9c reads from the non-irradiation signal memory unit 11a the X-ray detection signal I_{N} acquired immediately before the start of X-ray irradiation in the current imaging event, and acquires the X-ray detection signal I_{N} as a lag image. Thus, the lag image L=I_{N}. The lag image L acquired by the lag image acquiring unit 9c is written and stored in the lag image memory unit 11b.

(Step S7) Acquire X-ray Image in Current Imaging

With completion of the X-ray irradiation in the current imaging event, the image processor 9 performs various processes to acquire an X-ray image based on an X-ray detection signal resulting from the irradiation. This X-ray image is referenced X. The X-ray image corresponds to the radiographic image serving an intended purpose in this invention.

(Step S8) Lag Correction

The lag correcting unit 9a reads the lag image L acquired in step S6 from the lag image memory unit 11b, and subtracts the lag image L from the X-ray image acquired in step S7. An X-ray image Y after the lag correction is expressed by Y=X−L

In actual situations, the timing of X-ray irradiation in the current imaging event is not necessarily determined beforehand. Therefore, the time of reaching K=N+1 is not necessarily known in advance. Then, in actual situations, steps S2-S5 described above are repeated for each sampling time interval, and the sampling time reaching the start of X-ray irradiation in the current imaging event in step S3 is regarded as the time of reaching K=N+1. Where the timing of X-ray irradiation in the current imaging event is determined in advance, the time of reaching K=N+1 is also known in advance, of course. In such a case, a value of N may be set in advance so that the sampling time may reach the start of X-ray irradiation in the current imaging event in accordance with the timing of reaching K=N+1.

According to the first embodiment having the described construction, the lag correcting unit 9a performs a lag correction of a lag-behind part by eliminating the lag-behind part from an X-ray detection signal. The non-irradiation signal acquiring unit 9b acquires a plurality of X-ray detection signals (I₀, I₁, I₂, . . . , I_{N-1} and I_{N} in the first embodiment) in time of non-irradiation before X-ray irradiation in an imaging event. The lag image acquiring unit 9c acquires a lag image L based on the X-ray detection signals acquired by the non-irradiation signal acquiring unit 9b. The lag correction is carried out by the lag correcting unit 9a noted above by subtracting from X-ray image X the lag image L acquired by the lag image acquiring unit 9c noted above.

Thus, there is no need to carry out a lag correction by performing recursive computations the number of times radiation detection signals (e.g. X-ray detection signals in the first embodiment) are sampled, as described in Japanese Unexamined Patent Publication No. 2004-242741 noted hereinbefore. A lag-behind part may be eliminated from a radiation detection signal (X-ray detection signal) in a simple way. Further, there is no need to use backlight as used in Japanese Unexamined Patent Publication No. H9-9153 noted hereinbefore. This avoids complication of the apparatus construction.

In the first embodiment, and also in the second and third embodiments to follow, a plurality of X-ray detection signals are acquired in time of non-irradiation after lapse of the predetermined time (i.e. the waiting time T_{W} in the first embodiment) from X-ray irradiation in a preceding imaging event. Consequently, a plurality of X-ray detection signals are acquired in time of non-irradiation before X-ray irradiation in a current imaging event.

When the X-ray irradiation in the preceding imaging event is completed and a transition is made to a state of non-irradiation, short time constant components or medium time constant components of a lag-behind part attenuate in a short time. After their attenuation, long time constant components become dominant, and remain with substantially the same intensity. Consequently, when an X-ray detection signal is acquired immediately after completion of the X-ray irradiation in the preceding imaging event, short and medium time constant components are included in the signals acquired. The lag-behind part having the short and medium time constant components cannot be eliminated from the signal accurately.

Thus, in the first embodiment, a plurality of X-ray detection signals are acquired in time of non-irradiation after lapse of the predetermined time from the X-ray irradiation in the preceding imaging event. Consequently, a plurality of X-ray detection signals are acquired in time of non-irradiation before X-ray irradiation in the current imaging event. The signals may be acquired in a state of including only the long time constant components which remain after lapse of the predetermined time. The signals are free from the short and medium time constant components, and a lag-behind part having the long time constant components may be eliminated accurately.

### Second Embodiment

Next, the second embodiment of this invention will be described with reference to the drawings.

Like reference signs will be used to identify like parts which are the same as in the first embodiment and will not be described again. A fluoroscopic apparatus in the second embodiment is similar to the apparatus in the first embodiment, and only the series of signal processing by the lag correcting unit 9a, non-irradiation signal acquiring unit 9b and lag image acquiring unit 9c is different from that in the first embodiment.

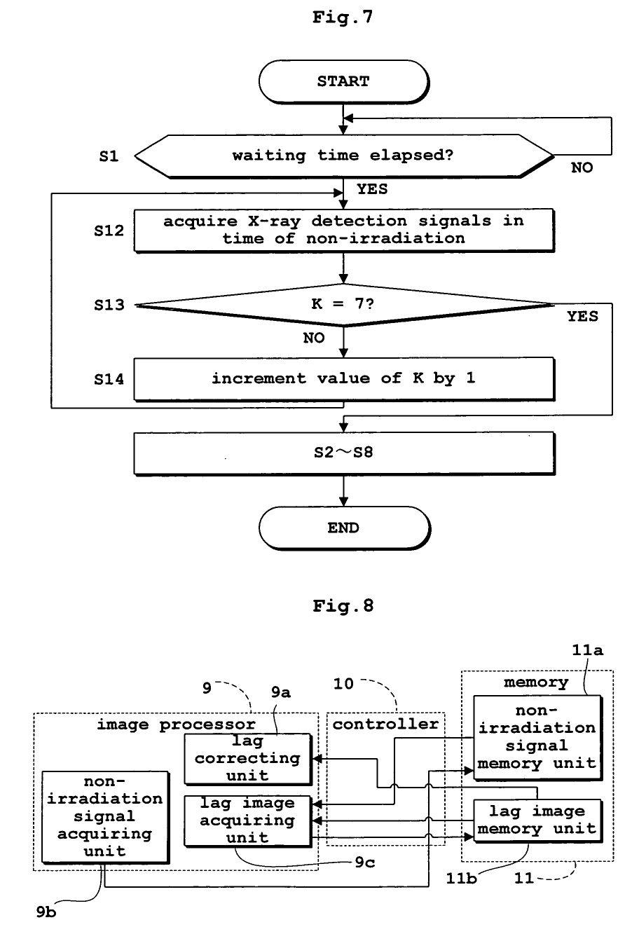

The series of signal processing by the lag correcting unit 9a, non-irradiation signal acquiring unit 9b and lag image acquiring unit 9c in the second embodiment will be described with reference to the flow chart of FIG. 7. Like numerals are affixed to like steps in the first embodiment and will not be described again.

(Step S1) Waiting Time Elapsed?

As in the first embodiment, a checking is made whether or not the waiting time T_{W} has elapsed from the end of X-ray irradiation in the preceding imaging event. Upon lapse of the waiting time T_{W}, the operation proceeds to next step S12.

(Step S12) Acquire X-ray Detection Signals in Time of Non-irradiation

As in the first embodiment, X-ray detection signals are successively acquired at sampling time intervals (e.g. 1/30 second) in time of non-irradiation after lapse of the waiting time T_{W}. In the second embodiment, as will become clear from the following description, the signals from the first X-ray detection signal I₀ acquired immediately after the waiting time T_{W} to the seventh X-ray detection signal I₆ remain stored in the non-irradiation signal memory unit 11a, instead of being discarded, until acquisition of the eighth X-ray detection signal I₇ (i.e. K=7). It is to be noted that steps S12-S15 are repeated at each of the sampling time intervals.

(Step S13) K=7?

A checking is made whether or not subscript K has reached 7, that is whether the sampling time has reached to the eighth (i.e. K=7). When K=7, the operation jumps to step S2. Otherwise, next step S14 is executed.

(Step S14) Increment Value of K by 1

As in the first embodiment, the value of subscript K is incremented by 1 for a next sampling. X-ray detection signals I_{K} acquired by the non-irradiation signal acquiring unit 9b in step S12 are successively written and stored in the non-irradiation signal memory unit 11a until acquisition of the eighth X-ray detection signal I₇ (i.e. K=7). At this time, X-ray detection signal I_{K-1} acquired before X-ray detection signal I_{K} is not discarded but remains stored in the non-irradiation signal memory unit 11a until eight X-ray detection signals accumulate in the non-irradiation signal memory unit 11a. Then, the operation returns to step S12 for a next sampling, and repeats steps S12-S14 for each of the sampling time intervals.

(Step S2)-(Step S8)

When the sampling time has reached the start of X-ray irradiation for the current imaging event in step S13, steps S2-S8 similar to the first embodiment are executed. However, eight X-ray detection signals are constantly stored in the non-irradiation signal memory unit 11a, and when the latest X-ray detection signal is newly stored in the non-irradiation signal memory unit 11a in step S5, the oldest X-ray detection signal only is discarded. When the sampling time has reached the start of X-ray irradiation in the current imaging event in step S13, a lag image L is created based on the eight signals from (N−6)th X-ray detection signal I_{N-7} to (N+1)th X-ray detection signal I_{N} acquired in step S2. Specifically, a lag image is derived from an average of these signals (L=ΣIᵢ/8, where Σ is a total of i=N−7 to N). The process from acquisition of the lag image L to the lag correction is the same as in the first embodiment, and its description is omitted.

According to the second embodiment having the described construction, as in the first embodiment, the lag correction of a lag-behind part is performed by eliminating the lag-behind part from an X-ray detection signal acquired. At this time, a plurality of X-ray detection signals (I₀, I₁, I₂, . . . , I_{N-1} and I_{N} in the second embodiment) are acquired in time of non-irradiation before X-ray irradiation in an imaging event, and a lag image L is created based on these X-ray detection signals. The lag correction is carried out by subtracting the lag image L from an X-ray image. Thus, the lag-behind part may be eliminated from the X-ray detection signal easily.

In the first embodiment, random noise components of X-ray image Y after the lag correction become 2^{1/2} times those of image X, thereby lowering the signal-to-noise ratio by 41% (=(2^{1/2}−1)). In order to suppress this deterioration, the second embodiment, as distinct from the first embodiment, derives the lag image L by directly using the plurality of X-ray detection signals (I_{N-7}, I_{N-6}, . . . , I_{N-1} and I_{N} in the second embodiment). In this case, the random noise components of X-ray image Y after the lag correction cause a deterioration no more than 6% of the X-ray image X before the correction. Thus, the lag correction can be effected without lowering the S/N ratio.

In the second embodiment, the lag image L is obtained by directly using eight X-ray detection signals. However, the invention is not limited to a particular number of X-ray detection signals to be used. Further, although the lag image L is derived from an average of the signals, the lag image L may be derived from a median. A histogram showing intensities of the signals may be formed, to derive a mode as lag image L from the histogram. Thus, the invention is not limited to a particular way of deriving the lag image L. The number of X-ray detection signals used corresponds to the predetermined number in this invention.

### Third Embodiment

Next, the third embodiment of this invention will be described with reference to the drawings.

FIG. 8 is a schematic view showing flows of data to and from an image processor and a memory in the third embodiment. Like reference signs will be used to identify like parts which are the same as in the first and second embodiments, and will not be described again. A fluoroscopic apparatus in the third embodiment is the same as the apparatus in the first and embodiments, except the flows of data to and from the image processor 9 and memory 11 shown in FIG. 8. The series of signal processing by the lag correcting unit 9a, non-irradiation signal acquiring unit 9b and lag image acquiring unit 9c also is different from those in the first and second embodiments.

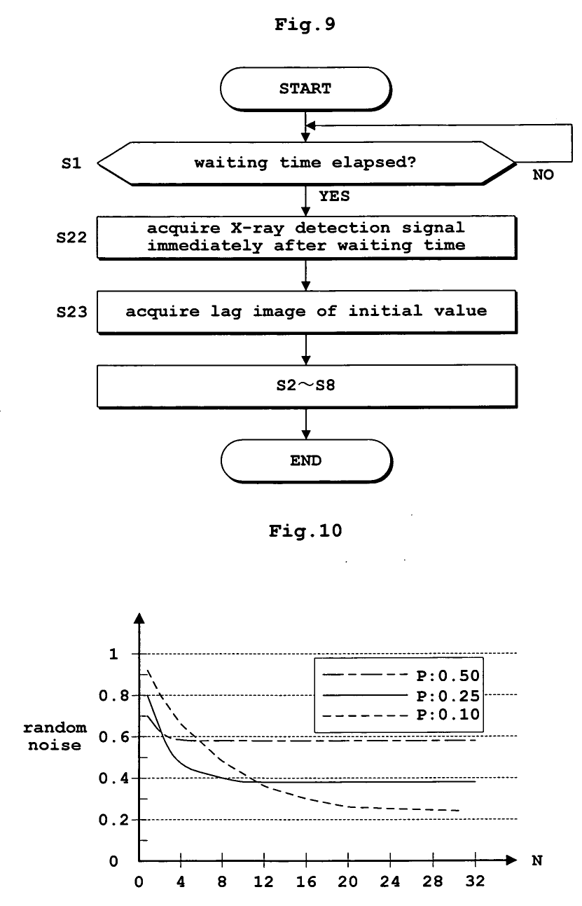

In the third embodiment, as shown in FIG. 8, the lag image acquiring unit 9c acquires a lag image by recursive computation based on the X-ray detection signals in time of non-irradiation read from the non-irradiation signal memory unit 11a and a preceding lag image read from the lag image memory unit 11b. The acquisition of a lag image by recursive computation will be described with reference to the flow chart of FIG. 9. The lag correcting unit 9a subtracts the lag image read from the lag image memory unit 11b from an X-ray image obtained in the current imaging event in the same way as in the first and second embodiments described hereinbefore.

Next, the series of signal processing by the lag correcting unit 9a, non-irradiation signal acquiring unit 9b and lag image acquiring unit 9c in the third embodiment will be described with reference to the flow chart of FIG. 9. Like numerals are affixed to like steps in the first and second embodiments and will not be described again.

(Step S1) Waiting Time Elapsed?

As in the first and second embodiments, a checking is made whether or not the waiting time T_{W} has elapsed from the end of X-ray irradiation in the preceding imaging event. Upon lapse of the waiting time T_{W}, the operation proceeds to next step S22.

(Step S22) Acquire X-ray Detection Signal Immediately after Waiting Time T_{W}

As in the first and second embodiments, X-ray detection signals are successively acquired at sampling time intervals (e.g. 1/30 second) in time of non-irradiation after lapse of the waiting time T_{W}. The first X-ray detection signal I₀ is acquired immediately after the waiting time T_{W}, which is written and stored in the non-irradiation signal memory unit 11a.

(Step S23) Acquire Lag Image of Initial Value

The lag image acquiring unit 9c reads this X-ray detection signal I₀ from the non-irradiation signal memory unit 11a, and acquires from the X-ray detection signal I₀ a lag image L₀ as an initial value of lag image L. The lag image L₀ of initial value acquired by the lag image acquiring unit 9c is written and stored in the lag image memory unit 11b.

(Step S2)-(Step S8)

After the lag image L₀ of initial value is acquired in step S23, steps S2-S8 similar to the first embodiment are executed. However, the X-ray detection signals acquired in time of non-irradiation in step S2 are the second X-ray detection signal I1 et seq. When acquiring the lag image L in step S6, an (N+1)th lag image L_{N} is derived by recursive computation from the X-ray detection signals I_{N} in time of non-irradiation read from the non-irradiation signal memory unit 11a and the preceding lag image L_{N-1} read from the lag image memory unit 11b. In the third embodiment, the lag image L_{N} is derived by a recursive weighted average (hereinafter referred to as “recursive process” as appropriate) from the following equation (1):
L_{N}=(1−P)×L_{N-1}+P×I_{N} (1)

In this process, I₀=L₀ as noted above. P is a load ratio which takes a value of 0 to 1.

When the latest lag image L_{N} is acquired as lag image L in step S6, only the lag image L_{N-1} preceding the lag image L_{N}, i.e. only the lag image L_{N-1} serving as the basis of the recursive process expressed by equation (1) above, is required. The remaining lag images L, i.e. lag image L_{N-2} before last and lag images L_{N-3}, . . . , L₁ and L₀ acquired earlier are unnecessary. Thus, once the latest lag image L_{N} is stored in the lag image memory unit 11b, only the immediately preceding lag image L_{N-1} is retained and the other lag images L are discarded. It is of course not absolutely necessary to discard the lag image L_{N-2} before last and earlier lag image L_{N-3} and so on.

According to the third embodiment having the described construction, as in the first and second embodiments, the lag correction described above is performed by subtracting the acquired lag image L from the X-ray image. Thus, a lag-behind part may be eliminated from the X-ray detection signal easily.

In the third embodiment, a plurality of X-ray detection signals are successively acquired at sampling time intervals (e.g. 1/30 second) in time of non-irradiation. Assuming a certain point in time of non-irradiation to be the (N+1)th, a lag image L is obtained based on a plurality of X-ray detection signals including the (N+1)th signal so far acquired successively. That is, an (N+1)th lag image L_{N} is obtained. For this purpose, the recursive computation is repeated based on the X-ray detection signal I_{N} acquired at the (N+1)th point of time, and a lag image L based on a plurality of X-ray detection signals successively acquired up to the Nth point of time before the (N+1)th point of time, that is the lag image L_{N-1} before the lag image L_{N}.

Whenever an X-ray detection signal is acquired in time of non-irradiation, the recursive computation is repeated based on the latest X-ray detection signal I_{N} acquired, and the lag image (i.e. preceding lag image) L_{N-1} resulting from a plurality of X-ray detection signals successively acquired in the past. The lag image L_{N} ultimately obtained is a goal image used as the basis for the lag correction. Only the newest lag image L_{N} obtained by recursive computation and the lag image L_{N-1} (i.e. the lag image used as the basis of the recursive computation) before the lag image L_{N} may be retained, with the other lag images (i.e. the lag images earlier than the above two lag images) discarded. Then, for example, the lag image memory unit 11b may have a storage region just for two frames, i.e. enough for storing two images. This provides an advantage of simplifying the construction.

In the third embodiment, the lag image is obtained by recursive process (see equation (1) above) which is a recursive weighted average as recursive computation, which realizes a lag correction with increased reliability. Regarding the S/N ratio, as shown in FIG. 10, when the load ratio P in equation (1) above is 0.25 (see the solid line in FIG. 10), the random noise components are reduced to 0.29 by repeating the recursive computation eight times or more. The random noise components of X-ray image Y after the lag correction cause a deterioration not exceeding 7% which is almost the same as the 6% in the second embodiment described hereinbefore where the lag image is obtained by directly using eight X-ray detection signals. Thus, the lag correction can be effected without lowering the S/N ratio.

This invention is not limited to the foregoing embodiments, but may be modified as follows:

(1) In each embodiment described above, the fluoroscopic apparatus has been described by way of example. This invention may be applied also to a fluoroscopic apparatus mounted on a C-shaped arm, for example. This invention may be applied also to an X-ray CT apparatus.

(2) In each embodiment described above, the flat panel X-ray detector (FPD) 3 has been described by way of example. This invention is applicable to any X-ray detectors in wide use.

(3) In each embodiment described above, the X-ray detector for detecting X rays has been described by way of example. This invention is not limited to a particular type of radiation detector which may, for example, be a gamma-ray detector for detecting gamma rays emitted from a patient dosed with radioisotope (RI), such as in an ECT (Emission Computed Tomography) apparatus. Similarly, this invention is applicable to any imaging apparatus that detects radiation, as exemplified by the ECT apparatus noted above.

(4) In each embodiment described above, the FPD 3 is a direct conversion type detector with a radiation (X rays in each embodiment) sensitive semiconductor for converting incident radiation directly into charge signals. Instead of the radiation sensitive type, the detector may be the indirect conversion type with a light sensitive semiconductor and a scintillator, in which incident radiation is converted into light by the scintillator, and the light is converted into charge signals by the light sensitive semiconductor.

(5) In each embodiment described above, an operation is started to acquire X-ray detection signals in time of non-irradiation after lapse of the predetermined time (i.e. the waiting time T_{W} in each embodiment) from X-ray irradiation in a preceding imaging event. Where the short and medium time constant components are at a negligible level, the acquisition of X-ray detection signals may be started simultaneously with a transition from the X-ray irradiation in the preceding imaging event to the non-irradiation state. This applies also to radiation other than X rays.

(6) In each embodiment described above, the lag image serving as the basis for the lag correction includes data of X-ray detection signal I_{N} acquired immediately before a start of X-ray irradiation in the current imaging event. It is not absolutely necessary to include the data of X-ray detection signal I_{N}. However, since the latest data is the most reliable, it is desirable, as in each embodiment, to obtain a lag image including the data of X-ray detection signal I_{N}, and perform the lag correction by subtracting the lag image. This applies also to radiation other than X rays.

(7) The third embodiment described above employs the recursive weighted average (recursive process) as shown in the foregoing equation (1). The recursive computation is not limited to the recursive weighted average, but may be an unweighted recursive computation. Thus, function f (I_{N}, L_{N-1}) expressed by X-ray detection signal I_{N} and lag image L_{N-1} may be expressed by the lag image L_{N} to serve the purpose.

This invention may be embodied in other specific forms without departing from the spirit or essential attributes thereof and, accordingly, reference should be made to the appended claims, rather than to the foregoing specification, as indicating the scope of the invention.

What is claimed is:

1. A radiographic apparatus for obtaining radiographic images based on radiation detection signals, comprising:
a radiation emitting device for emitting radiation toward an object under examination;
a radiation detecting device for detecting radiation transmitted through said object;
a lag correcting device for performing a lag correction of a lag-behind part by eliminating the lag-behind part from a radiation detection signal;
a non-irradiation signal acquiring device for acquiring a plurality of radiation detection signals in time of non-irradiation before irradiation of the radiation in an imaging event; and
a lag image acquiring device for acquiring a lag image based on the radiation detection signals acquired by the non-irradiation signal acquiring device;
wherein said lag correcting device is arranged to perform the lag correction by subtracting the lag image acquired by said lag image acquiring device from a radiographic image serving an intended purpose.

2. A radiographic apparatus as defined in claim 1, wherein said non-irradiation signal acquiring device is arranged to acquire a plurality of radiation detection signals in time of non-irradiation after lapse of a predetermined time from irradiation of the radiation in a preceding imaging event, which results in an acquisition of a plurality of radiation detection signals in time of non-irradiation before irradiation of the radiation in a current imaging event.

3. A radiographic apparatus as defined in claim 1, wherein:
said non-irradiation signal acquiring device is arranged to repeat a process of newly acquiring a radiation detection signal in time of said non-irradiation, and then discarding a radiation detection signal acquired at a previous point of time, which results in an acquisition of a radiation detection signal immediately preceding a start of irradiation of the radiation in the imaging event; and
said lag image acquiring device is arranged to acquire, as the lag image, said radiation detection signal immediately preceding the start of irradiation.

4. A radiographic apparatus as defined in claim 1, wherein:
said non-irradiation signal acquiring device is arranged to repeat a process of (A) acquiring radiation detection signals in time of non-irradiation, without discarding the radiation detection signals until a predetermined number of radiation detection signals are acquired, and (b) after the predetermined number is reached, discarding only an oldest one of the radiation detection signals when a new radiation detection signal is acquired in time of non-irradiation, which results in an acquisition of the predetermined number of radiation detection signals including a radiation detection signal immediately preceding a start of irradiation of the radiation in the imaging event; and
said lag image acquiring device is arranged to acquire the lag image based on the predetermined number of radiation detection signals including said radiation detection signal immediately preceding the start of irradiation.

5. A radiographic apparatus as defined in claim 1, wherein:
said non-irradiation signal acquiring device is arranged to acquire the plurality of radiation detection signals in time of said non-irradiation by successively acquiring the radiation detection signals; and
said lag image acquiring device is arranged to acquire said lag image based on a plurality of radiation detection signals successively acquired so far in time of non-irradiation including a given point of time, by repeating a recursive computation based on a radiation detection signal acquired at said given point of time, and a lag image derived from a plurality of radiation detection signals successively acquired so far and at points of time before said given point of time.

6. A radiation detection signal processing method for obtaining radiographic images based on radiation detection signals resulting from radiation emitted to and transmitted through an object under examination, said radiation detection signal processing method comprising the steps of:
acquiring a plurality of radiation detection signals in time of non-irradiation before irradiation of the radiation in an imaging event, for performing a lag correction of a lag-behind part by eliminating the lag-behind part from a radiation detection signal obtained;
acquiring a lag image based on the radiation detection signals acquired; and
performing said lag correction by subtracting the lag image acquired from a radiographic image serving an intended purpose.

7. A radiation detection signal processing method as defined in claim 6, wherein a plurality of radiation detection signals are acquired in time of non-irradiation after lapse of a predetermined time from irradiation of the radiation in a preceding imaging event, which results in an acquisition of a plurality of radiation detection signals in time of non-irradiation before irradiation of the radiation in a current imaging event.

8. A radiation detection signal processing method as defined in claim 6, wherein:
at least a radiation detection signal immediately preceding a start of irradiation of the radiation in the imaging event is acquired by repeating a process of acquiring a radiation detection signal in time of said non-irradiation; and
said radiation detection signal immediately preceding the start of irradiation is acquired as the lag image.

9. A radiation detection signal processing method as defined in claim 8, wherein:
the radiation detection signal immediately preceding the start of irradiation of the radiation in the imaging event is acquired by repeating a process of newly acquiring a radiation detection signal in time of said non-irradiation, and retaining a radiation detection signal acquired at a previous point of time; and
said radiation detection signal immediately preceding the start of irradiation is acquired as the lag image.

10. A radiation detection signal processing method as defined in claim 8, wherein:
the radiation detection signal immediately preceding the start of irradiation of the radiation in the imaging event is acquired by repeating a process of newly acquiring a radiation detection signal in time of said non-irradiation, and then discarding a radiation detection signal acquired at a previous point of time; and
said radiation detection signal immediately preceding the start of irradiation is acquired as the lag image.

11. A radiation detection signal processing method as defined in claim 10, wherein each of the radiation detection signals is acquired through sampling, and said radiation detection signal immediately preceding the start of irradiation in the imaging event is acquired by repeating processes of (1) acquiring a radiation detection signal in time of non-irradiation, (2) checking whether the imaging event has been reached; (3) incrementing the value of K by 1, and (4) discarding a radiation detection signal acquired at a previous point of time, where sampling points of time K are 0, 1, 2 and so on, and a first one of the radiation detection signals is acquired at a sampling point of time K=0, at each of sampling time intervals until the imaging event is found in process (2) to have been reached.

12. A radiation detection signal processing method as defined in claim 6, wherein:
radiation detection signals are acquired successively in time of non-irradiation, without discarding the radiation detection signals until a predetermined number of radiation detection signals are acquired;
a process is repeated, after the predetermined number is reached, for discarding only an oldest one of the radiation detection signals when a new radiation detection signal is acquired in time of non-irradiation, thereby acquiring the predetermined number of radiation detection signals including a radiation detection signal immediately preceding a start of irradiation of the radiation in the imaging event; and
the lag image is acquired based on the predetermined number of radiation detection signals including said radiation detection signal acquired immediately preceding the start of irradiation.

13. A radiation detection signal processing method as defined in claim 12, wherein:
each of the radiation detection signals is acquired through sampling, and the predetermined number of radiation detection signals are acquired by repeating processes of (1) acquiring a radiation detection signal in time of non-irradiation, (2) checking whether said predetermined number has been reached; and (3) incrementing the value of K by 1, where sampling points of time K are 0, 1, 2 and so on, and a first one of the radiation detection signals is acquired at a sampling point of time K=0, at each of sampling time intervals until the predetermined number is found in process (2) to have been reached; and
the lag image is acquired based on the predetermined number of radiation detection signals including said radiation detection signal immediately preceding the start of irradiation by repeating, after the prescribed number is reached, processes of (4) acquiring of the radiation detection signals in time of non-irradiation, (5) checking whether the imaging event has been reached; (6) incrementing the value of K by 1, and (7) discarding only the oldest one of the radiation detection signals, at each of the sampling time intervals until the imaging event is found in process (5) to have been reached.

14. A radiation detection signal processing method as defined in claim 12, wherein an average of the predetermined number of radiation detection signals including said radiation detection signal acquired immediately preceding the start of irradiation is acquired as the lag image.

15. A radiation detection signal processing method as defined in claim 6, wherein:
the plurality of radiation detection signals are acquired in time of said non-irradiation by successively acquiring the radiation detection signals; and
said lag image is acquired based on a plurality of radiation detection signals successively acquired so far in time of non-irradiation including a given point of time, by repeating a recursive computation based on a radiation detection signal acquired at said given point of time, and a lag image derived from a plurality of radiation detection signals successively acquired so far and at points of time before said given point of time.

16. A radiation detection signal processing method as defined in claim 15, wherein said recursive computation is a recursive weighted average.

17. A radiation detection signal processing method as defined in claim 16, wherein said lag image L_{N} is derived from the recursive weighted average expressed by;
L_{N}=(1−P)×L_{N-1}+P×I_{N} (on condition that lag image L₀ of initial value is radiation detection signal I₀ acquired first in time of non-irradiation),
where I_{N} is a radiation detection signal acquired at the given point of time, L_{N-1} is the lag image derived from the plurality of radiation detection signals successively acquired so far and at points of time before said given point of time, and P is a load ratio.

18. A radiation detection signal processing method as defined in claim 15, wherein said lag image L_{N} is derived from the recursive computation of function f (I_{N}, L_{N-1}) expressed by radiation detection signal I_{N} and lag image L_{N-1}=L_{N} (on condition that lag image L₀ of initial value is radiation detection signal I₀ acquired first in time of non-irradiation), where I_{N} is a radiation detection signal acquired at the given point of time, and L_{N-1} is the lag image derived from the plurality of radiation detection signals successively acquired so far and at points of time before said given point of time.
